(19) United States
(12) Patent Application Publication
(10) Pub. No.: US 2016/0049879 A1
(43) Pub. Date: Feb. 18, 2016

(54) POWER SUPPLY AND POWER SUPPLYING METHOD

(71) Applicant: Samsung Electro-Mechanics Co., Ltd., Suwon-Si (KR)

(72) Inventors: Gyu Min PARK, Suwon-si (KR); Ki Hong KIM, Suwon-si (KR)

(73) Assignee: SAMSUNG ELECTRO-MECHANICS CO., LTD., Suwon-Si (KR)

(21) Appl. No.: 14/826,926

(22) Filed: Aug. 14, 2015

(30) Foreign Application Priority Data
Aug. 18, 2014 (KR) 10-2014-0106820

(51) Int. Cl. H02M 3/335

(52) U.S. Cl. CPC H02M 3/33576

(57) ABSTRACT

Disclosed herein are a power supply having a wide output voltage range and a power supplying method, and the power supply according to the present disclosure includes a power unit adjusting magnitude of a driving voltage in response to a turn ratio of a first winding and a second winding, and a controlling unit outputting a control signal that adjusts the turn ratio of the first winding and the second winding in response to the magnitude of the driving voltage.

This application claims the foreign priority benefit under 35 U.S.C. Section [120, 119, 119(e)] of Korean Patent Application Serial No. 10-2014-0106820 entitled “Power Supply and Power Supplying Method” filed on Aug. 18, 2014, which is hereby incorporated by reference in its entirety into this application.

### BACKGROUND

1. Technical Field

Embodiments of the present invention relates to a power supply and a power supplying method.

2. Description of the Related Art

In general, a light emitting diode (LED) lighting power supply may allow uniform brightness to be maintained by controlling a current supplied to an LED module to be uniform. The LED lighting power supply may control the current supplied to the LED module to be uniform using a method pulse width modulation (PWM), pulse frequency modulation (PFM), or the like. In case of the LED module, an LED forward voltage Vf may be determined depending on the number of LEDs which are connected in series with each other and/or connected in parallel to each other, and power consumption of each LED. In addition, the LED lighting power supply has a range of an output voltage, and if the Vf of the LED module is within the range of the output voltage, the LED lighting power supply may uniformly emit light which is desired by the LED module by controlling the current supplied to the LED module. However, if the Vf of the LED module is out of the range of the output voltage, there is a problem that the LED lighting power supply does not emit uniform light because it may not control the current.

### SUMMARY

An object of the present disclosure is to provide a power supply having a wide output voltage range and a power supplying method.

According to an exemplary embodiment of the present disclosure, there is provided a power supply including: a transformer including a primary winding and a secondary winding, the secondary winding including at least a first sub-winding and a second sub-winding; a power converting unit connected to the primary winding of the transformer and switching a current flowing in the primary winding; a rectifying unit including a first switch that selects the first sub-winding depending on a turn-on/turn-off operation and a second switch that selects the first sub-winding and the second sub-winding depending on the turn-on/turn-off operation, and rectifying the current flowing in the selected first sub-winding or the first sub-winding and the second sub-winding depending on the turn-on/turn-off operation of the first switch and the second switch, so as to be supplied to a channel; and a controlling unit outputting a control signal that selects and turns on the first switch in the case in which an amount of current supplied to the channel by the rectifying unit is less than a predetermined value and selects and turns on the second switch in the case in which the amount of current is larger than the predetermined value.

According to another exemplary embodiment of the present disclosure, there is provided a power supply including: a power unit including a transformer generating a driving voltage induced in a secondary winding by a current flowing in a primary winding and a power converting unit controlling the current flowing in the primary winding; a rectifying unit including a first switch and a second switch, differently determining the number of turns of the secondary winding depending on a case in which the first switch is turned on and a case in which the second switch is turned on, and rectifying a current flowing in the secondary winding so as to be supplied to a channel; and a controlling unit outputting a control signal controlling the rectifying unit.

According to another exemplary embodiment of the present disclosure, there is provided a power supplying method that applies a voltage induced in a secondary winding of a transformer by a current flowing in a primary winding of the transformer to a channel, including: comparing a first reference voltage with a sensed voltage corresponding to a current flowing in the channel; and turning-on a first switch that sets a turn ratio of the primary winding and the secondary winding to be small and simultaneously turning-off a second switch that sets the turn ratio of the primary winding and the secondary winding to be large, or turning-off the first switch and turning-on the second switch, in response to magnitudes of the first reference voltage and the sensed voltage.

Additional aspects and/or advantages will be set forth in part in the description which follows and, in part, will be apparent from the description, or may be learned by practice of the invention.

### BRIEF DESCRIPTION OF DRAWINGS

These and/or other aspects and advantages will become apparent and more readily appreciated from the following description of the embodiments, taken in conjunction with the accompanying drawings of which:

FIG. 1 is a circuit diagram showing one example of a power supply according to the present disclosure;

FIG. 2 is a circuit diagram showing a connection relationship between controlling unit, and a first switch and a second switch shown in FIG. 1;

FIG. 3 is a circuit diagram showing a second example of the power supply according to the present disclosure;

FIG. 4 is a structural diagram showing one example of the controlling unit shown in FIG. 3;

FIG. 5 is a flowchart showing an operation of the controlling unit shown in FIG. 4;

FIG. 6 is a circuit diagram showing a third example of the power supply according to the present disclosure;

FIG. 7 is a circuit diagram showing a fourth example of the power supply according to the present disclosure;

FIG. 8 is a circuit diagram showing a fifth example of the power supply according to the present disclosure; and

FIG. 9 is a circuit diagram showing a sixth example of the power supply according to the present disclosure.

### DESCRIPTION OF EMBODIMENT(S)

The acting effects and technical configuration with respect to the objects of a power supply and a power supplying method according to the present disclosure will be clearly understood by the following description in which exemplary embodiments of the present disclosure are described with reference to the accompanying drawings.

Further, when it is determined that the detailed description of the known art related to the present disclosure may obscure the gist of the present disclosure, the detailed description thereof will be omitted. In the description, the terms “first”, “second”, and so on are used to distinguish one element from another element, and the elements are not defined by the above terms.

Exemplary embodiments of the present disclosure will be described in detail with reference to the accompanying drawings. These exemplary embodiments will be described in detail for those skilled in the art in order to practice the present disclosure. It should be appreciated that various exemplary embodiments of the present disclosure are different but do not have to be exclusive. For example, specific shapes, configurations, and characteristics described in an exemplary embodiment of the present disclosure may be implemented in another exemplary embodiment without departing from the spirit and the scope of the present disclosure. In addition, it should be understood that position and arrangement of individual components in each disclosed exemplary embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings.

Hereinafter, exemplary embodiments of the present disclosure will be described in detail with reference to the accompanying drawings so that those skilled in the art may easily practice the present disclosure.

FIG. 1 is a circuit diagram showing one example of a power supply according to the present disclosure.

Referring to FIG. 1, a power supply 100 may include a power unit 110 including a transformer 101 applying a voltage induced in a secondary winding L2 by a current flowing in a primary winding L1 to a channel 140 and a power converting unit 102 controlling the current flowing in the primary winding L1, a rectifying unit 120 including a first switch S1 and a second switch S2, differently determining the number of turns of the secondary winding L2 depending on a case in which the first switch S1 is turned on and a case in which the second switch S2 is turned on, and rectifying a current flowing in the secondary winding L2, and a controlling unit 130 outputting a control signal controlling the rectifying unit 120.

The power unit 110 may adjust an amount of current flowing in the primary winding L1 by a turn-on/turn-off operation of the power converting unit 102 connected to the primary winding L1 of the transformer 101 so as to switch the current flowing in the primary winding L1. The power converting unit 102 may include a field effect transistor (FET), a metal oxide semiconductor (MOS) transistor, or a bipolar junction transistor (BJT). However, the present disclosure is not limited thereto. The secondary winding L2 of the transformer 101 may include a first sub-winding L21 and a second sub-winding L22. In addition, the first sub-winding L21 or the first sub-winding L21 and the second sub-winding L22 may be selected depending on an operation of the rectifying unit 120, so as to differently adjust the number of turns of the secondary winding L2 of the transformer 101. Thereby, the turn ratio of the primary winding L1 and the secondary winding L2 of the transformer 101 may be differently adjusted, such that magnitude of the voltage induced in the secondary winding L2 may be different even though the current flowing in the primary winding L1 is uniform.

The rectifying unit 120 may include the first switch S1 and the second switch S2 that select the first sub-winding L21 or the first sub-winding L21 and the second sub-winding L22 depending on the turn-on/turn-off operation. The first sub-winding L21 and the second sub-winding L22 may have one tap T1 formed therebetween, and the first switch S1 may have one end connected to the tap T1 and the other end connected to a second node N2. The second switch S2 may have one end connected to the other end of the second sub-winding L22 and the other end connected to a second node N2. In addition, the rectifying unit 120 may include a capacitor C. The capacitor C may have a first electrode connected to the first node N1 and a second electrode connected to the second node N2. The capacitor C may be connected between the first node N1 and the second node N2 and the channel 140 may be connected between the first node N1 and the second node N2. A current rectified by the rectifying unit 120 may be smoothed so as to be supplied to the channel 140. The second node N2 may be connected to a ground. In addition, the rectifying unit 120 may rectify a driving current flowing in the first sub-winding L21 or the first sub-winding L21 and the second sub-winding L22 that are selected by the turn-on/turn-off operation of the first switch S1 and the second switch S2, so as to be supplied to the channel 140. If the first switch S1 is turned on and the second switch S2 is turned off in the rectifying unit 120, the first sub-winding L21 is selected, and consequently, magnitude of the voltage induced in the secondary winding L2 may be determined by a turn ratio of the primary winding L1 and the first sub-winding L21. If the first switch S1 is turned off and the second switch S2 is turned on in the rectifying unit 120, the first sub-winding L21 and the second sub-winding L22 are selected, and consequently, the magnitude of the voltage induced in the secondary winding L2 may be determined by a turn ratio of the primary winding L1, and the first sub-winding L21 and the second sub-winding L22.

The controlling unit 130 may transfer the control signal, so as to control the turn-on/turn-off of the first switch S1 and the second switch S2. The first switch S1 and the second switch S2 may be alternately turned on/turned off. The controlling unit 130 may compare a sensed voltage Vsens obtained by sensing magnitude of a driving current flowing in the channel 140 with a first reference voltage Ref1, turn on the first switch S1 in the case in which the sensed voltage Vsens is less than the first reference voltage, and turn on the second switch S2 in the case in which the sensed voltage Vsens is larger than the first reference voltage. In the case in which the first switch S1 and the second switch S2 are a transistor, the controlling unit 130 may transfer the control signal to gate electrodes of the first switch S1 and the second switch S2, respectively, so as to turn on the first switch S1 or the second switch S2. In addition, the controlling unit 130 may compare the sensed voltage Vsens obtained by sensing the magnitude of the driving current flowing in the channel 140 with a second reference voltage, so as to determine a ratio of the turn-on/turn-off (i.e. duty ratio) of the power converting unit 102. To this end, the controlling unit 130 may further include a pulse width modulation (PWM) unit 131 that controls a flow of the current flowing in the primary winding so as to correspond to the magnitude of the driving current flowing in the channel. The PWM unit 131 may control the flow of the current flowing in the primary winding L1 by adjusting the ratio of the turn-on/turn-off of the power converting unit 102. However, the present disclosure is not limited thereto, but the controlling unit 130 may control the flow of the current flowing the primary winding L1 by adjusting a turned on/turned off frequency of the power converting unit 102.

According to an exemplary embodiment, the power supply 100 may further include a sensing unit sensing the sensed voltage Vsens and transfer the sensed voltage Vsens sensed by the sensing unit to the controlling unit 130. The sensing unit may include a sensing resistor Rs connected to the channel 140 and generate the sensed voltage Vsens by a current flowing in the sensing resistor Rs. Magnitude of the sensed voltage Vsens may correspond to magnitude of the current flowing in the sensing resistor Rs. In addition, the power converting unit 102 may include a first converting switch FET1 of which a turn-on/turn-off is controlled by the PWM unit 131. The PWM unit 131 may adjust an amount of current flowing in the primary winding L1 by comparing the sensed voltage Vsens with a second reference voltage so as to adjust a ratio of a turn-on/turn-off of the first converting switch FET1. However, the present disclosure is not limited thereto, but the amount of current flowing in the primary winding L1 may be adjusted by changing a frequency of the turn-on/turn-off of the first converting switch FET1. In addition, the channel 140 may include a plurality of LEDs which may be connected in series with each other or in parallel to each other and receive the driving current so as to emit light.

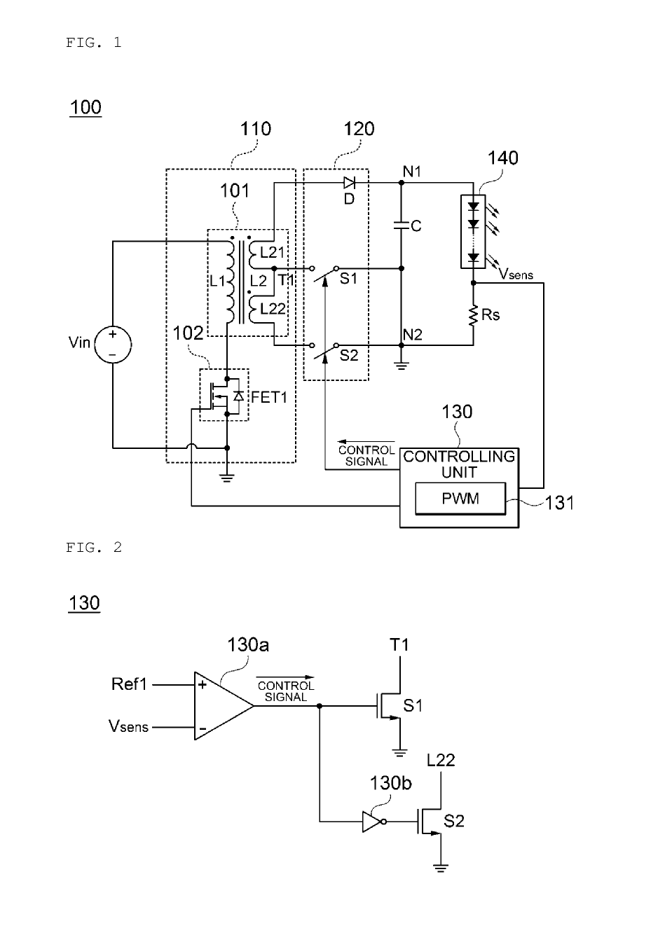

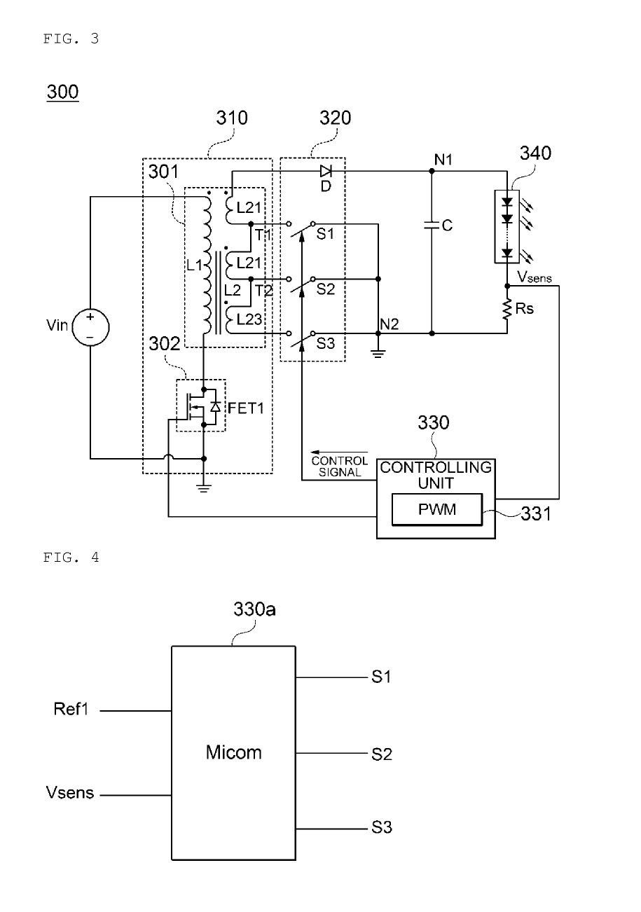

FIG. 2 is a circuit diagram showing a connection relationship between controlling unit, and a first switch and a second switch shown in FIG. 1.

Referring to FIG. 2, the controlling unit 130 may include a comparator 130a, wherein the comparator 130a may have a positive (+) input terminal to which the first reference voltage Ref1 is applied and a negative (−) input terminal to which the sensed voltage Vsens is applied. In addition, in the case in which a voltage level of the sensed voltage Vsens is lower than a voltage level of the first reference voltage Ref1, the comparator 130a may output a high signal, and in the case in which the voltage level of the sensed voltage Vsens is higher than the voltage level of the first reference voltage Ref1, the comparator 130a may output a low signal. In addition, the comparator 130a may include two output terminals, wherein one output terminal may be connected to the first switch S1 and the other output terminal may be connected to the second switch S2 through an inverter 130b. The first switch S1 and the second switch S2 may be an NMOS type transistor and the output signal of the comparator 130a may be directly transferred to a gate electrode of the first switch S1 and may be reversed by the inverter 130b so as to be transferred to a gate electrode of the second switch S2. Therefore, the first switch S1 and the second switch S2 may not be simultaneously turned on. However, the first switch S1 may be an NMOS transistor and the second switch S2 may be a PMOS transistor. In this case, the inverter 130 may not be necessary.

In addition, the comparator 130a may output the control signal that turns-on the first switch S1 setting a ratio of turns of the primary winding L1 and the secondary winding L2 to be small and simultaneously turns-off the second switch S2 setting the ratio of turns of the primary winding L1 and the secondary winding L2 to be large, or turns-off the first switch S1 and turns-on the second switch S2, in response to the magnitudes of the first reference voltage Ref1 and the sensed voltage Vsens.

FIG. 3 is a circuit diagram showing a second example of the power supply according to the present disclosure.

Referring to FIG. 3, a power supply 300 may include a power unit 310 including a transformer 301 applying a voltage induced in a secondary winding L2 by a current flowing in a primary winding L1 to a channel 340 and a power converting unit 302 controlling the current flowing in the primary winding L1, a rectifying unit 320 including a first switch S1, a second switch S2, and a third switch S3, differently determining the number of turns of the secondary winding L2 depending on a case in which the first switch S1 is turned on, a case in which the second switch S2 is turned on, and a case in which the third switch S3 is turned on, respectively, and rectifying a current flowing in the secondary winding L2, and a controlling unit 330 outputting a control signal controlling the rectifying unit 320.

The power unit 310 may adjust an amount of current flowing in the primary winding L1 by a turn-on/turn-off operation of the power converting unit 302 connected to the primary winding L1 of the transformer 101 so as to switch the current flowing in the primary winding L1. The power converting unit 302 may include a power converting switch FET1. Although the power converting switch FET1 is shown as a field effect transistor (FET), it is not limited thereto. For example, the power converting switch FET1 may be a metal oxide semiconductor (MOS) transistor or a bipolar junction transistor (BJT). The secondary winding L2 of the transformer 301 may include a first sub-winding L21, a second sub-winding L22, and a third sub-winding L23. In addition, the first sub-winding L21 or the first sub-winding L21 and the second sub-winding L22 or the first sub-winding L21, the second sub-winding L22, and the third sub-winding L23 may be selected depending on an operation of the rectifying unit 320, so as to differently adjust the number of turns of the secondary winding L2 of the transformer 301. Therefore, the turn ratio of the primary winding L1 and the secondary winding L2 of the transformer 301 may be differently adjusted, such that magnitude of the voltage induced in the secondary winding L2 may be different even though the current flowing in the primary winding L1 is uniform.

The rectifying unit 320 may include the first switch S1 that selects the first sub-winding L21 depending on the turn-on/turn-off operation, the second switch S2 that selects the first sub-winding L21 and the second sub-winding L22 depending on the turn-on/turn-off operation, and the third switch S3 that selects the first sub-winding L21, the second sub-winding L22, the third sub-winding L23 depending on the turn-on/turn-off operation. In addition, the rectifying unit 320 may include a capacitor C. The capacitor C may have a first electrode connected to the first node N1 and a second electrode connected to the second node N2. The second node N2 may be connected to a ground. In addition, the channel 340 may be connected to the first node N1 and the second node N2. The rectifying unit 320 may rectify a current flowing in the first sub-winding L21 or the first sub-winding L21 and the second sub-winding L22 or the first sub-winding L21, the second sub-winding L22, and the third sub-winding L23 that are each selected by the turn-on/turn-off operation of the first switch S1, the second switch S2, and the third switch S3, so as to be supplied to the channel 340. If the first switch S1 is turned on and the second switch S2 and the third switch S3 are turned off in the rectifying unit 320, the first sub-winding L21 is selected, and consequently, magnitude of the voltage induced in the secondary winding L2 may be determined by a turn ratio of the primary winding L1 and the first sub-winding L21. In addition, if the first switch S1 and the third switch S3 are turned off and the second switch S2 is turned on in the rectifying unit 320, the first sub-winding L21 and the second sub-winding L22 are selected, and consequently, the magnitude of the voltage induced in the secondary winding L2 may be determined by a turn ratio of the primary winding L1, and the first sub-winding L21 and the second sub-winding L22. In addition, if the first switch S1 and the second switch S2 are turned off and the third switch S3 is turned on in the rectifying unit 320, the first sub-winding L21, the second sub-winding L22, and the third sub-winding L23 are selected, and consequently, the magnitude of the voltage induced in the secondary winding L2 may be determined by a turn ratio of the primary winding L1, and the secondary winding L2 having a summation of the first sub-winding L21, the second sub-winding L22, and the third sub-winding L23. In order to allow the rectifying unit 320 to select the first sub-winding L21 or the first sub-winding L21 and the second sub-winding L22 or the first sub-winding L21, the second sub-winding L22, and the third sub-winding L23, the first switch S1 may have one end connected to one tap T1 which is close to one end among taps T1 and T2 between one end and the other end of the secondary winding L2, and the other end connected to the second node N2. The second switch S2 may have one end connected to one tap T2 which is close to the other among the taps T1 and T2 between the one end and the other end of the secondary winding L2, and the other end connected to the second node N2. The third switch S3 may have one end connected to the other end of the secondary winding L2 and the other end connected to the second node N2. The first switch S1 to the third switch S3 may be a transistor, and one end of the first switch S1 to the third switch S3 may be a source electrode and the other end thereof may be a drain electrode. The capacitor C may be connected between the first node N1 and the second node N2 and smooth a current rectified by the rectifying unit 320 so as to be supplied to the channel 340. The second node N2 may be connected to a ground. In addition, the rectifying unit 320 may perform a half-wave rectification.

The controlling unit 330 may transfer the control signal, so as to control the turn-on/turn-off of the first switch S1 to the third switch S3. The controlling unit 330 may compare a sensed voltage Vsens obtained by sensing the magnitude of the driving current flowing in the channel 340 with a first reference voltage Ref1, so as to allow one switch of the first switch S1 to the third switch S3 to be turned on.

Here, although a case in which the rectifying unit 320 of the power supply 300 includes the first switch S1 to the third switch S3 and the secondary winding L2 includes the first sub-winding L21 to the third sub-winding L23 is shown, the present disclosure is not limited thereto. For example, a larger number of switches and sub-windings may be included. In addition, the controlling unit 330 may turn-on one switch of a plurality of switches by comparing the sensed voltage Vsens with the first reference voltage Ref1.

According to an exemplary embodiment, the power supply 300 may further include a sensing unit sensing the sensed voltage Vsens and transfer the sensed voltage Vsens sensed by the sensing unit to the controlling unit 330. The sensing unit may include a sensing resistor Rs connected to the channel 340 and generate the sensed voltage Vsens by a current flowing in the sensing resistor Rs. Magnitude of the sensed voltage Vsens may correspond to magnitude of the current flowing in the sensing resistor Rs. In addition, the power converting unit 302 may include a first converting switch FET1 of which a turn-on/turn-off is controlled by the PWM unit 331. The PWM unit 331 may adjust an amount of current flowing in the primary winding L1 by comparing the sensed voltage Vsens with a second reference voltage so as to adjust a ratio of a turn-on/turn-off of the first converting switch FET1. However, the present disclosure is not limited thereto, but the amount of current flowing in the primary winding L1 may be adjusted by changing a frequency of the turn-on/turn-off of the first converting switch FET1. In addition, the channel 340 may include a plurality of LEDs which may be connected in series with each other or in parallel to each other and receive the driving current so as to emit light.

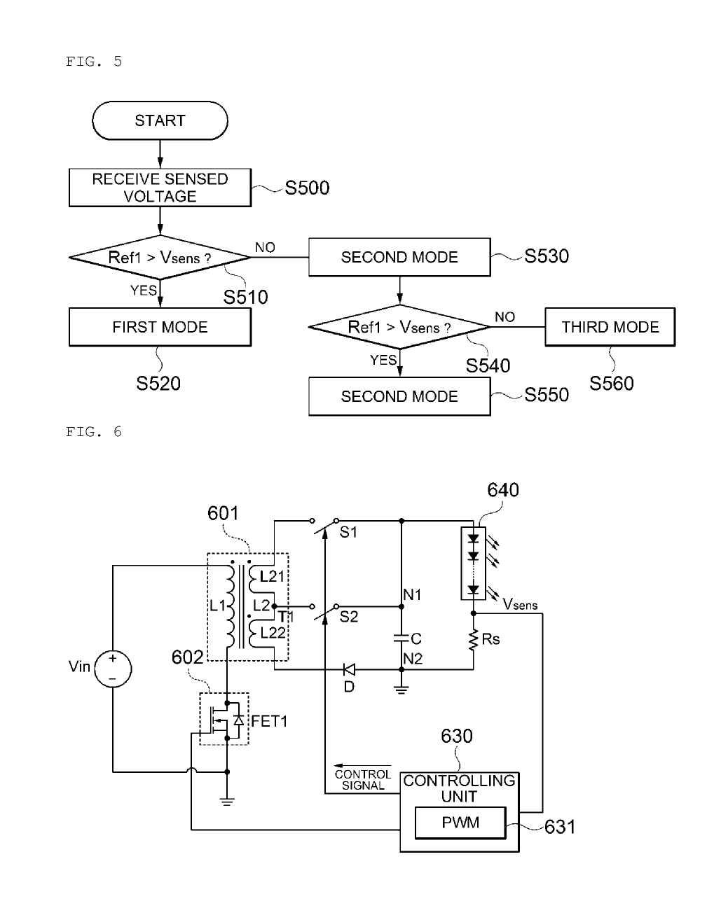

FIG. 4 is a structural diagram showing one example of the controlling unit shown in FIG. 3 and FIG. 5 is a flowchart showing an operation of the controlling unit shown in FIG. 4.

Referring to FIGS. 4 and 5, the controlling unit 330 may be configured of one chip such as a micom 330a and the controlling unit 330 may receive the sensed voltage Vsens obtained by sensing the magnitude of the current by the sensing unit and the first reference voltage Ref1 (S500). In addition, the controlling unit 330 may receive the sensed voltage Vsens and compare the sensed voltage Vsens with the first reference voltage Ref1 (S510) and perform a first mode if the sensed voltage Vsens is less than the first reference voltage Ref1 (S520). The first mode turns on the first switch S1 and turns off the second switch S2 and the third switch S3, so as to allow the current to flow in only the first sub-winding L21 of the secondary winding L2. The power supply 300 may generate a voltage applied to the channel 340 by the turn ratio of the primary winding L1 and the first sub-winding L21 in the first mode. In addition, if the sensed voltage Vsens is larger than the first reference voltage Ref1 as a result of the comparison of the sensed voltage Vsens and the first reference voltage Ref1 in S510, the controlling unit 330 may perform a second mode (S530). The second mode turns off the first switch S1 and the third switch S3 and turns on the second switch S2, so as to allow the current to flow in only the first sub-winding L21 and the second sub-winding L22 of the secondary winding L2. The power supply 300 may generate the voltage applied to the channel 340 by the turn ratio of the primary winding L1, and the first sub-winding L21 and the second sub-winding L22 in the second mode. The sensed voltage Vsens may be continuously compared to the first reference voltage Ref1 during a process in which the second mode is performed (S540), wherein if the sensed voltage Vsens is less than the first reference voltage Ref1, the controlling unit 330 may continuously perform the second mode (S550). However, if the sensed voltage Vsens is larger than the first reference voltage Ref1 in S540, the controlling unit 330 may perform a third mode (S560). The third mode turns off the first switch S1 and the second switch S2 and turns on the third switch S3, so as to allow the current to flow in only the first sub-winding L21, the second sub-winding L22, and the third sub-winding L23 of the secondary winding L2. The power supply 300 may generate the voltage applied to the channel 340 by the turn ratio of the primary winding L1, and the first sub-winding L21, the second sub-winding L22, and the third sub-winding L23 in the third mode.

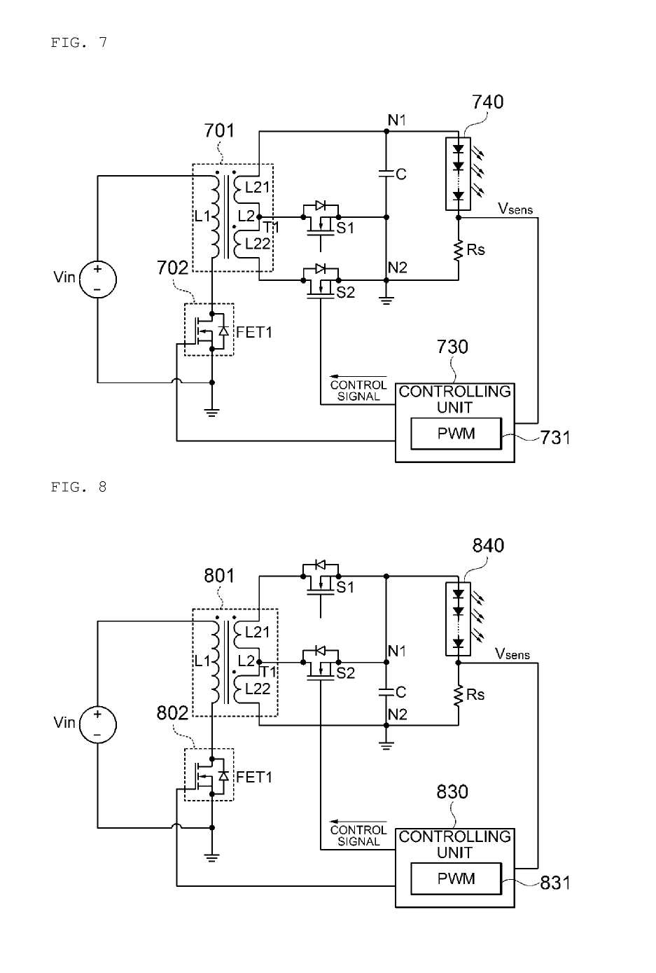

FIG. 6 is a circuit diagram showing a third example of the power supply according to the present disclosure.

A power supply 600 is different from the power supply 100 shown in FIG. 1 in a connection relationship with a rectifying unit 620. Only a difference with the power supply 100 shown in FIG. 1 will be described with reference to FIG. 6. The rectifying unit 620 may have a capacitor C connected between a first node N1 and a second node N2. In addition, the first switch S1 may have one end connected to one end of the secondary winding L2 and the other end connected to the first node N1 and a channel 640. In addition, the second switch S2 may have one end connected the tap T1 between one end and the other end of the secondary winding L2 and the other end connected to the first node N1. In addition, a cathode electrode of a diode D may be connected to the other end of the secondary winding L2 and an anode electrode of the diode D may be connected to the second node N2. The power supply 600 having the rectifying unit 620 connected thereto as described above may select the first sub-winding L21 or the first sub-winding L21 and the second sub-winding L22 by the turn-on/turn-off operation of the first switch S1 and the second switch S2. Here, the first sub-winding L21 may mean the part of the secondary winding L2 connected between the first switch S1 and the second switch S2 and the second sub-winding L22 may mean the part of the secondary winding L2 connected between the second switch S2 and the diode D.

FIG. 7 is a circuit diagram showing a fourth example of the power supply according to the present disclosure and FIG. 8 is a circuit diagram showing a fifth example of the power supply according to the present disclosure.

Referring to FIGS. 7 and 8, the rectifying unit 120 of the power supply 100 does not include a separate diode, and the first switch S1 and the second switch S2 are connected by the FET, thereby making it possible to rectify the current flowing in the secondary winding L2 by the respective body diodes of the first switch S1 and the second switch S2. Thereby, since the rectifying unit 120 does not require a separate transistor, the number of elements may be reduced. In addition, the rectifying unit 120 may serve as a synchronization rectifier.

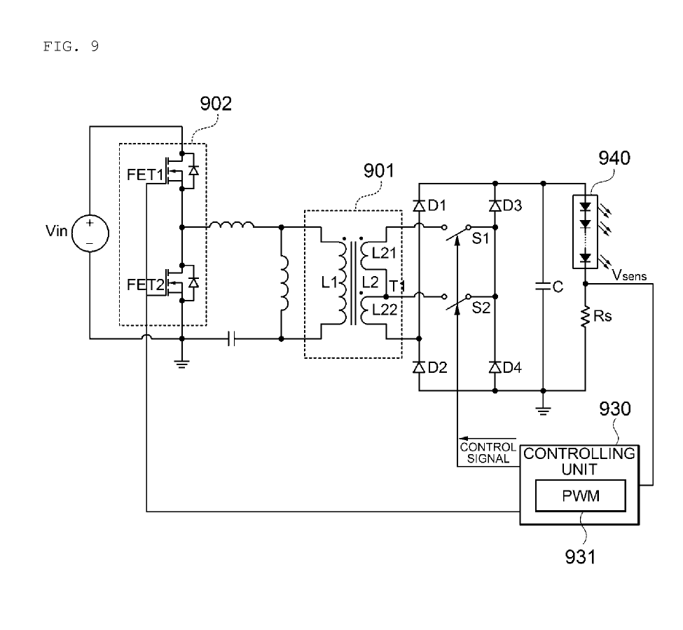

FIG. 9 is a circuit diagram showing a sixth example of the power supply according to the present disclosure.

Referring to FIG. 9, the power supply 100 uses an LLC converter and a power converting unit 902 may include two converting switches FET1 and FET2 which are alternately turned on/turned off and may adjust a direction of the current flowing in the primary winding L1 of the transformer 101 by the two converting switches FET1 and FET2. The secondary winding L2 may include a first sub-winding L21 and a second sub-winding L22. The rectifying unit 120 may include bridge diodes D1, D2, D3, and D4, the first switch S1, and the second switch S2, and if the first switch S1 is turned on and the second switch S2 is turned off, the first sub-winding L21 may be selected, and if the second switch S2 is turned on and the first switch S1 is turned off, both the first sub-winding L21 and the second sub-winding L22 may be selected, thereby making it possible to differently set the voltage induced in the secondary winding L2 depending on the turn-on/turn-off operation of the first switch S1 and the second switch S2. In addition, the rectifying unit 120 may perform a full-wave rectification by the bridge diodes D1, D2, D3, and D4. A current which is full-wave rectified by the bridge diodes D1, D2, D3, and D4 may be smoothed by the capacitor C and may be supplied to a channel 940. Therefore, a of voltage may supply a driving current having magnitude which is suitable for another channel 940.

In the claims of the present specification, components represented as means for performing specific function are intended to include any way performing the specific function, and the components may include any form of software including a combination of circuit components performing the specific function, or firmware, microcode, or the like coupled to appropriate circuits in order to perform software for performing the specific function.

According to the exemplary embodiments of the present disclosure, in the power supply and the power supplying method, since the power supply has a wide range of the output voltage, a desired operation may be performed by connecting the load such as the LED module having various power consumptions, or the like to one power supply.

In the present specification, ‘an exemplary embodiment’ of the present disclosure and other modified expressions mean that a certain feature, structure, or characteristic is included in at least one exemplary embodiment of the present disclosure. Accordingly, the expression “an exemplary embodiment” and other modified examples in the present specification may not necessarily denote the same exemplary embodiment.

In the present specification, a term ‘connected’, ‘connecting’, or the like used herein and various modification of this term are defined as being directly connected to another component or indirectly connected through another component. Unless explicitly described to the contrary, a singular form also includes a plural form in the present specification. In addition, components, steps, operations, and/or elements mentioned by ‘comprise’ or ‘comprising’ used in the present specification mean the existence or addition of one or more other components, steps, operations, elements and apparatus.

What is claimed is:

1. A power supply comprising:
a transformer including a primary winding and a secondary winding, the secondary winding including at least a first sub-winding and a second sub-winding;
a power converting unit connected to the primary winding of the transformer and switching a current flowing in the primary winding;
a rectifying unit including a first switch that selects the first sub-winding depending on a turn-on/turn-off operation and a second switch that selects the first sub-winding and the second sub-winding depending on the turn-on/turn-off operation, and rectifying the current flowing in the selected first sub-winding or the first sub-winding and the second sub-winding depending on the turn-on/turn-off operation of the first switch and the second switch, so as to be supplied to a channel; and
a controlling unit outputting a control signal that selects and turns on the first switch in the case in which an amount of current supplied to the channel by the rectifying unit is less than a predetermined value and selects and turns on the second switch in the case in which the amount of current is larger than the predetermined value.

2. The power supply according to claim 1, wherein the controlling unit compares a first reference voltage with a sensed voltage corresponding to the current supplied to the channel so as to output the control signal.

3. The power supply according to claim 1, wherein the controlling unit includes a comparator that compares a first reference voltage with a sensed voltage corresponding to the current supplied to the channel so as to generate the control signal, and transfers the control signal to the first switch, and an inverter that inverts the control signal output from the comparator so as to be transferred to the second switch.

4. The power supply according to claim 1, wherein the secondary winding further includes a third sub-winding and a third switch that selects the first sub-winding, the second sub-winding, and the third sub-winding depending on a turn-on/turn-off operation, and
the controlling unit includes a micom that compares a first reference voltage with a sensed voltage corresponding to the current supplied to the channel and the micom selects and turns on one of the first switch, the second switch, and the third switch in response to a difference between the first reference voltage and the sensed voltage.

5. The power supply according to any one of claims 2, further comprising a sensing unit generating the sensed voltage,
wherein the sensed voltage generated by the sensing unit is transferred to the controlling unit.

6. The power supply according to claim 1, wherein the controlling unit determines a turn-on/turn-off operation of the power converting unit in response to magnitude of the current flowing in the channel.

7. The power supply according to claim 1, wherein the rectifying unit performs a half-wave rectification.

8. The power supply according to claim 1, wherein the rectifying unit performs a full-wave rectification.

9. A power supply comprising:
a power unit including a transformer generating a driving voltage induced in a secondary winding by a current flowing in a primary winding and a power converting unit controlling the current flowing in the primary winding;
a rectifying unit including a first switch and a second switch, differently determining the number of turns of the secondary winding depending on a case in which the first switch is turned on and a case in which the second switch is turned on, and rectifying a current flowing in the secondary winding so as to be supplied to a channel; and
a controlling unit outputting a control signal controlling the rectifying unit.

10. The power supply according to claim 9, wherein the rectifying unit further includes a first capacitor connected between a first end and a second end and a diode connected between one end of the secondary winding and the first end, the first switch is connected between a tap between one end and the other end of the secondary winding and a second node, and the second switch is connected between the other end of the secondary winding and the second node.

11. The power supply according to claim 9, wherein the rectifying unit further includes a first capacitor connected between a first end and a second end, and the first switch and the second switch each include a field effect transistor (FET).

12. The power supply according to claim 10, wherein the controlling unit compares a first reference voltage with a sensed voltage corresponding to the current supplied to the channel so as to output the control signal.

13. The power supply according to claim 10, wherein the controlling unit includes a comparator that compares a first reference voltage with a sensed voltage corresponding to the current supplied to the channel so as to generate the control signal, and transfers the control signal to the first switch, and an inverter that inverts the control signal output from the comparator so as to be transferred to the second switch.

14. The power supply according to claim 13, further comprising a sensing unit generating the sensed voltage,
wherein the sensed voltage generated by the sensing unit is transferred to the controlling unit.

15. The power supply according to claim 9, wherein the secondary winding includes a first sub-winding and a second sub-winding, the first sub-winding is selected depending on a turn-on/turn-off operation of the first switch, and the first sub-winding and the second sub-winding are selected depending on a turn-on/turn-off operation of the second switch.

16. The power supply according to claim 15, wherein the secondary winding further includes a third sub-winding, and the rectifying unit further includes a third switch that selects the first sub-winding, the second sub-winding, and the third sub-winding depending on a turn-on/turn-off operation.

17. The power supply according to claim 16, wherein the controlling unit includes a micom that compares a first reference voltage with a sensed voltage corresponding to the current supplied to the channel and the micom selects and turns on one of the first switch, the second switch, and the third switch in response to a difference between the first reference voltage and the sensed voltage.

18. The power supply according to claim 9, wherein the controlling unit includes a pulse width modulation (PWM) unit that controls a flow of the current flowing in the primary winding in response to magnitude of a driving current flowing in the channel.

19. The power supply according to claim 9, wherein the power converting unit includes a first converting switch, and a flow of the current flowing in the primary winding is controlled by a turn-on/turn-off operation of the first converting switch.

20. The power supply according to claim 9, wherein the power converting unit includes a first converting switch and a second converting switch that are alternately turned on/turned off, and a flow of the current flowing in the primary winding is controlled by turn-on/turn-off operations of the first converting switch and the second converting switch.

21. A power supplying method that applies a voltage induced in a secondary winding of a transformer by a current flowing in a primary winding of the transformer to a channel, the power supplying method comprising:
comparing a first reference voltage with a sensed voltage corresponding to a current flowing in the channel; and
turning-on a first switch that sets a turn ratio of the primary winding and the secondary winding to be small and simultaneously turning-off a second switch that sets the turn ratio of the primary winding and the secondary winding to be large, or turning-off the first switch and turning-on the second switch, in response to magnitudes of the first reference voltage and the sensed voltage.

22. The power supplying method according to claim 21, further comprising determining a duty ratio in response to magnitude of the current flowing in the channel and controlling the current flowing in the primary winding according to the duty ratio.
